(19) United States
(12) Patent Application Publication
(10) Pub. No.: US 2019/0357707 A1
(43) Pub. Date: Nov. 28, 2019

(54) SMART BEVERAGE CONTAINER SYSTEMS AND METHODS

(71) Applicant: Greg Bugaj, Edmond, OK (US)

(72) Inventor: Greg Bugaj, Edmond, OK (US)

(21) Appl. No.: 15/990,595

(22) Filed: May 26, 2018

(51) Int. Cl. A47G 19/22; H05B 3/26

(52) U.S. Cl. CPC A47G 19/2227; H02J 7/025; H05B 3/26; A47G 19/2288

(57) ABSTRACT

The disclosure includes a beverage container system comprising a container having a bottom surface, an open top, and a sidewall extending between the bottom surface and the open top. The system may include at least one sensor coupled to the container whereby the at least one sensor is arranged and configured to capture data associated with the beverage. The system may also include a display screen coupled to the container and communicatively coupled to the at least one sensor. In some embodiments, the display screen is located along the sidewall and the display screen is arranged and configured to display at least one data associated with the beverage. The system may include a power source coupled to the container and electrically coupled to the display screen.

### BACKGROUND

### Field

Various embodiments disclosed herein relate to smart beverage container systems and methods.

### Description of Related Art

Typically beverages are consumed in low-cost containers, such as cans, mugs, glassware, and the like. People often drink beverages with no regard to the rich data that may be gathered and analyzed by the container and provided to the person. Additionally, the beverage containers don't have the ability to perform useful functions, such as heat the beverage to a desired temperature. Thus, there is a need for beverage container systems and methods that gather data and perform useful functions.

### SUMMARY

The disclosure includes a beverage container system that includes a container having a bottom surface, an open top, and a sidewall extending between the bottom surface and the open top, the container arranged and configured to receive a beverage. The system may include at least one sensor coupled to the container, the at least one sensor arranged and configured to capture data associated with the beverage. Furthermore, the system may include a display screen coupled to the container and communicatively coupled to the at least one sensor, the display screen located along the sidewall, the display screen arranged and configured to display at least one data associated with the beverage. Even still, the system may include a power source coupled to the container and electrically coupled to the display screen.

The system may include a communication module coupled to the container, communicatively coupled to the display screen, and electrically coupled to the power source. The system may also include a remote computing device communicatively coupled to the communication module.

The remote computing device may be communicatively coupled to the communication module via Bluetooth. The remote computing device may comprise at least one of a smart phone and a tablet device. The system may thereby be arranged and configured to determine an inventory level of an item associated with the beverage and automatically order, from a vendor, the item associated with the beverage at a predetermined time interval The remote computing device may be arranged and configured to run a software application arranged and configured to allow a user to remotely control at least one of the display screen, at least one sensor, and the power source. The at least one sensor may be arranged and configured to determine at least one of a temperature of the beverage, a fill level of the beverage, and an inventory level of an item associated with the beverage.

In some embodiments, the power source comprises a battery. The system may include a power input coupled to the container and electrically coupled to the power source. The power input may comprise a USB Type-C port arranged and configured to receive power.

The power input may be arranged and configured to wirelessly receive power from an external power source. The external power source may define a flat surface configured to receive the bottom surface of the container. The external power source may include a USB Type-C port arranged and configured to receive power. In some embodiments, the external power source is arranged and configured to generate heat and conductively heat the bottom surface of the container when the bottom surface is physically placed on the flat surface.

The system may also include at least one button communicatively coupled to the display screen, communicatively coupled to the at least one sensor, and electrically coupled to the power source. In some embodiments, the at least one button is arranged and configured to cause the at least one sensor to capture the data associated with the beverage. The at least one button may be arranged and configured to cause the display screen to display an indication of the data associated with the beverage.

The system may include a heating element coupled to the container, electrically coupled to the power source, and communicatively coupled to the at least one button, the heating element arranged and configured to heat at least one of the sidewalls and the bottom surface to thereby heat the beverage. The at least one button may be arranged and configured to activate and deactivate the heating element.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a beverage container system 10, according to some embodiments.

FIG. 2 illustrates a beverage container system 10 coupled to an external power source 42, and communicatively coupled to a remote computing device 30, according to some embodiments.

FIG. 3 illustrates a plurality of beverage container system 10a-c communicatively coupled together in a smart beverage container network 60, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### LIST OF REFERENCE NUMERALS

10—Beverage container system
12—Container
14—Bottom surface
16—Open top
18—Sidewall
19—Lid
20—At least one sensor
22—Data
24—Display screen
26—Power source
28—Communication module
30—Remote computing device
40—Container power input
42—External power source
44—External power input
46—Secondary external power source
48—Wireless charging elements
50—External wireless charging elements
52—At least one button
54—Heating elements
60—Smart beverage container network

As the internet of things continues to evolve, the notion of connectivity has permeated across almost every aspect of life. One area that has remained relatively unconnected are the drinkware and beverage industries. As such, this disclosure intends to provide systems that thrust drinkware into the internet of things. Such systems may thereby gather data, help people make informed choices, promote healthy habits, and generally, enrich peoples' lives. Such systems come in the form of a smart beverage container system 10 that can provide helpful information to better understand and monitor liquid consumption habits, such as calorie and sugar consumption, and measure a variety of inputs to help prevent dehydration. Smart beverage container systems 10 can even be used to monitor inventory levels of beverages in one's home or workplace. In some embodiments, smart beverage containers can be used to monitor and even regulate the beverage in the container, such as alcohol content, presence of caffeine, or temperature. Communication between a smart beverage container and a remote communication device can help users monitor hourly, daily, and weekly liquid consumption habits. This may be helpful for healthy living, dieting, and the like. Smart beverage containers can also be used to heat beverages using nontraditional, mobile methods, giving a user additional time and flexibility in their day.

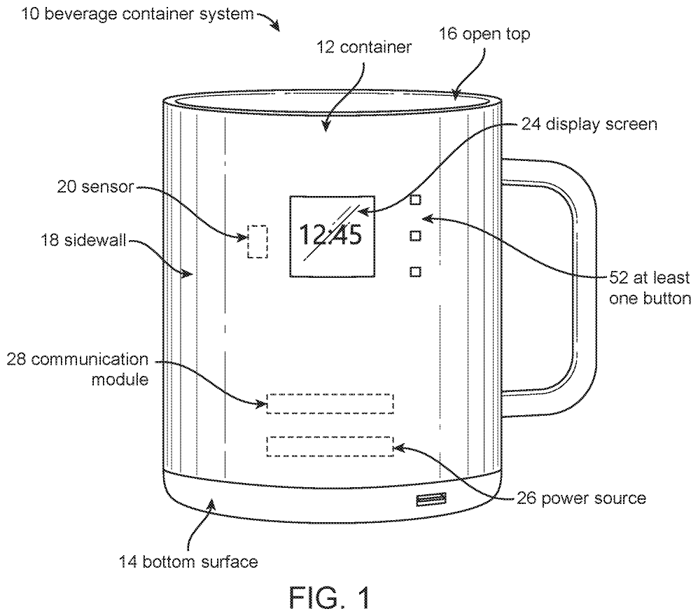

As shown in FIG. 1, the disclosure includes a beverage container system 10 (herein after referred to as “system 10”). In many embodiments, the system 10 includes a container 12 having a bottom surface 14, an open top 16, and a sidewall 18 extending between the bottom surface 14 and the open top 16. It should be appreciated that the container 12 may be arranged and configured to receive a beverage.

The container 12 may embody a variety of forms, such as a coffee mug, beer mug, wine glass, table glass, flask, water bottle, kettle, coffee pot, pitcher, and the like. It should be appreciated that the container 12 may be made from any such material commonly used in the drinkware industry, such as ceramic, metal, glass, plastic, and any conventional or non-conventional beverage container material. It should also be appreciated that the container 12 can include a lid 19.

In some embodiments, the system 10 includes at least one sensor 20 coupled to the container 12. The at least one sensor 20 may be arranged and configured to capture data 22 associated with the beverage. Data 22a captured by the at least one sensor 20 may include liquid presence, liquid level, beverage type, temperature, pH level, caffeine content, alcohol content, sugar content, refill count, and the like.

The system 10 may also include a display screen 24 coupled to the container 12 and communicatively coupled to the at least one sensor 20. The display screen 24 may be located along the sidewall 18. In many embodiments, the display screen 24 may be arranged and configured to display at least one data 22a associated with the beverage. The display screen may be digital, analog, light emitting diode (LED), liquid crystal display (LCD), organic light emitting diode (OLED), plasma and the like.

The system 10 can also include a power source 26 coupled to the container 12 and electrically coupled to the display screen 24. The power source 26 may be electrically coupled to the display screen 24 via a wired or wireless connection. The power source 26 may be implemented in a variety of forms, such as a chemical battery (e.g., alkaline), a rechargeable battery (e.g. lithium, nickel), a solar power source, a radio wave power harvester, a thermoelectric energy harvester, and the like.

Furthermore, the system 10 may include a communication module 28 arranged and configured to allow the system 10 to be communicatively coupled to a network, such as the Internet of things. The communication module 28 may be coupled to the container 12, communicatively coupled to the display screen 24, and electrically coupled to the power source 26. The communication module 28 can be electrically coupled to the power source 26 via a wired or wireless connection.

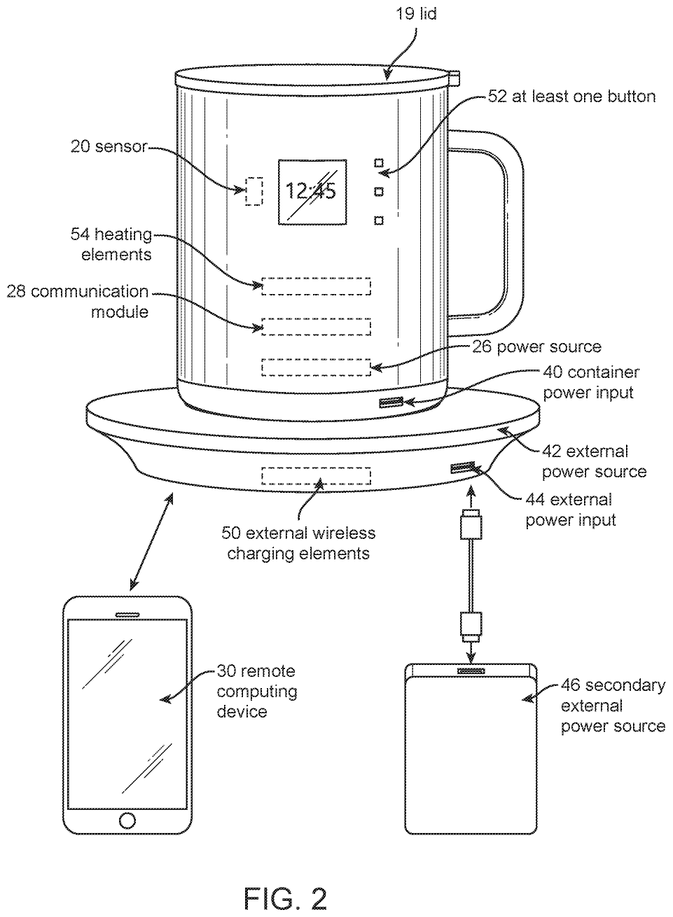

Referring now to FIG. 2, the communication module 28 may be communicatively coupled to a remote computing device 30. The remote computing device 30 may include a smart phone, tablet device, desktop computer, laptop computer, smart watch, and any device arranged and configured to communicate via a wireless connection. Some embodiments may enable wireless communication between the communication module 28 and the remote computing device 30, via Wi-Fi, Bluetooth, infrared, radio frequency, Near Field Communication, and the like.

In some embodiments, the remote computing device 30 may include a remote server. The remote server may be arranged and configured to determine an inventory level of an item associated with the beverage within the container 12. The remote server may automatically order, from a vendor, an item associated with the beverage. The remote server may be arranged and configured to order the item associated with the beverage at a predetermined time interval or when the item reaches a predetermined inventory threshold.

In some embodiments, the remote computing device 30 communicates with the communication module 28 to record a history of beverages received by the container 12 using the at least one sensor 20 to collect at least one data 22a. The at least one data 22a may be an amount and/or type of beverage. The remote computing device may use the at least one data 22a collected to monitor beverages received by container 12 and consumed by a user.

For example, if a user uses single serve coffee pods to brew coffee, the system 10 may record the number of cups of coffee brewed and decrease the predetermined inventory level in accordance. When the inventory level of single serve coffee pods reaches a predetermined threshold, the system 10 may automatically reorder single serve coffee pods from a vendor. Similarly, if a user uses a traditional coffee maker, the system 10 may record the amount of coffee as a unit of measurement (e.g., ounces) received by system 10. For example, the system 10 may determine that 100 ten ounce cups of coffee are stocked in inventory. Once the inventory level of the amount of coffee reaches a predetermined threshold, the remote server may automatically reorder coffee.

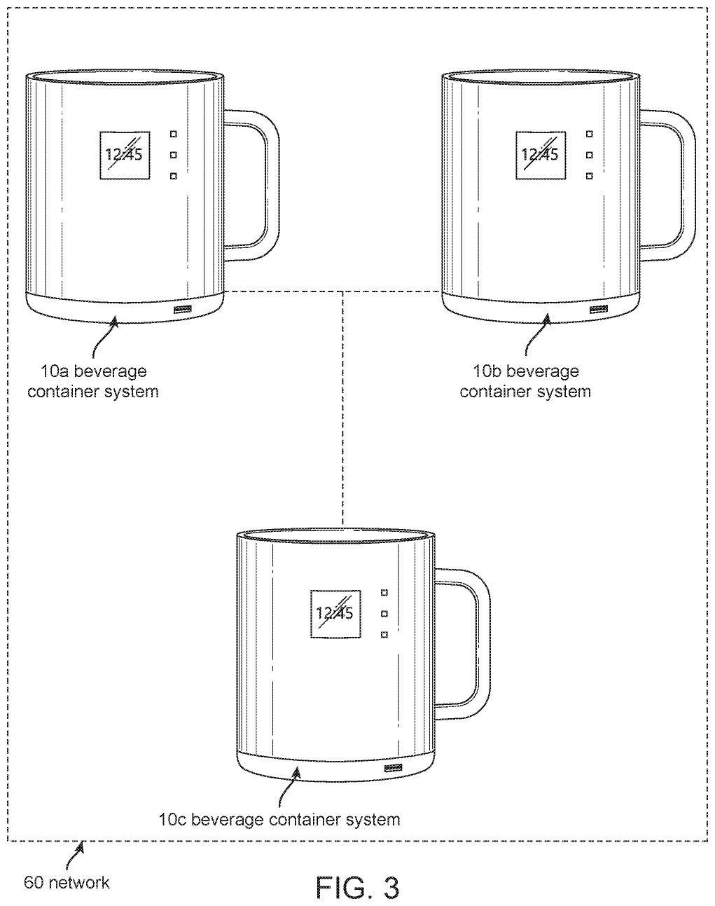

As shown in FIG. 3, a plurality of beverage container systems 10a, 10b, and 10c may be communicatively coupled to create a smart beverage container network 60 (herein after referred to as “network 60”). The network 60 may monitor beverage consumption in an environment. For example, the at least one data 22a collected by the systems 10a, 10b, 10c may be the amount of milk consumed in a household. The system 10 may then automatically reorder milk from a vendor once the level of milk reaches a predetermined threshold.

Additionally, the system 10 may alert a user of the consumption and/or inventory level of the milk based on at least one data 22a collected from network 60. In some embodiments, the system 10 helps parents monitor their children's liquid consumption habits, and alerts a user in the environment that the milk in their home has reached a predetermined inventory level. Similarly, this embodiment may be used in an office environment to monitor employee liquid consumption to help an employer determine the most popular beverages that employees consume, and automatically reorder a beverage that has reached a predetermined threshold.

With reference to FIG. 2, the remote computing device 30 may be arranged and configured to run a software application that can be arranged and configured to allow a user to remotely control at least one of the display screen 24, the at least one sensor 20, and the power source 26. The communication module 28 may be communicatively coupled with the remote computing device 30, which may allow the user to remotely control the aforementioned aspects of the system 10.

In several embodiments, a user may control the information displayed on the display screen 24. The information may include time, date, beverage type in the container 12, power status, a user's liquid consumption history in a variety of time intervals (e.g., hour, day, week), various content levels of the beverage (e.g., caffeine content, alcohol content, sugar content), and the like. A user may also use the software application to control the use and function of the at least one sensor 20. For example, if the beverage in the container 12 is water, a user may disable the at least one sensor 20 that may detect the composition (e.g., sugar content) of a beverage. This may be performed to reserve power in the system 10. A user may also use the software application to control the power source 26. For example, a user may disable the device remotely, control which attributes of the system 10 are in use, enable a low power mode to conserve energy, and the like. The software application may allow a user to monitor liquid consumption habits. In some embodiments, the software application generates summaries and/or reports of the at least one data 22a collected using the at least one sensor 20. Such summaries may include water consumption, alcohol consumption, caffeine consumption, liquid sugar consumption, and the like. The summaries and/or reports may be presented in a variety of categories, such as the aforementioned, and/or in time frames, such as hourly, daily, weekly, monthly, and the like. The software application may also allow user input. User input can include personal data, such as height, weight, age, gender, exercise habits, and the like. This may allow a user to monitor their liquid consumption habits, and determine health data from these habits. The software application may even determine health data of the user based on user input and data, such as liquid consumption data, collected from the system 10.

It should be appreciated that the software application may be implemented in multiple remote computing devices 30 to control or monitor one or more environments of the systems 10. This implementation of the software application may allow multiple users in one or more environments. The software application may allow multiple users to share consumption habits, beverage inventory levels, and the like on the same platform. For example, parents may be able to view their child's liquid consumption habits remotely. In several embodiments, the at least one sensor 20 is arranged and configured to determine at least one characteristic of a beverage in system 10. Such characteristics may include, but are not limited to, temperature, fill level, composition of the beverage, alcohol content, sugar content, calorie content, caffeine content, presence of artificial flavors, presence of artificial dyes, acidity, protein, carbonation, bitterness units, sodium content, carbonation and the like.

Further in reference to FIG. 2, in many embodiments the power source 26 comprises a battery. The battery may be lithium ion, lithium polymer, nickel cadmium, nickel-metal hydride, any rechargeable battery technology available, and the like. A container power input 40 may be coupled to the container 12 and electrically coupled to the power source 26. The container power input 40 can comprise a USB Type-C port arranged and configured to receive power.

In many embodiments, the container power input 40 may be arranged and configured to wirelessly receive power from an external power source 42. The external power source 42 may wirelessly charge the system 10 via wireless charging elements 48 coupled to container 12 and external wireless charging elements 50 coupled to the external power source 42. The wireless charging elements 48 may be electrically coupled to power source 26. Wireless charging methods may include inductive charging, radio charging, resonance charging, near field charging, any wireless charging technology and/or techniques available, and the like. The external power source 42 may be defined as a flat surface configured to receive the bottom surface 14 of the container 12. As well, the external power source 42 can comprise a USB Type-C port arranged and configured to receive power.

As well, the system 10 and external power source 42 may both be charged by connecting the respective USB Type-C ports to a secondary external power source 46. The secondary external power source 46 may embody a USB wall outlet, a laptop computer with a USB port, a portable battery with a USB port, a laptop computer with a USB Type-C port, and any device that accepts a USB Type-C male connector that is plugged into the container power input 40 or the external power input 44.

In some embodiments, the external power source 42 is arranged and configured to generate heat and conductively heat the bottom surface 14 of the container 12 when the bottom surface 14 is physically placed on the flat surface of external power source 42. Heat can be generated within external power source 42, pass through conductors comprising the flat surface of the external power source 42 and the bottom surface 14, and transfer to the beverage inside container 12. This method may be used to control and/or regulate the temperature of the beverage inside the container 12.

For example, conductive heat may be generated by the external power source 42 to heat up coffee inside the container 12 that has cooled down below a predetermined temperature threshold. Conductive heating may also be used to maintain the temperature of a beverage inside container 12 once the beverage has reach a predetermined temperature. Such predetermined temperatures may be configured by the user (by user input), or may be configured by default parameters.

Furthermore, conductive heating may be used to warm a beverage that may only require a slight temperature increase. For example, some parents give children a glass of warm milk before bed. System 10 and external power source 42 may be used to warm the glass of milk to an optimal drinking temperature. Generally, the system 10 may be arranged and configured to heat the beverage to any desired temperature. Other methods of heating, such as stovetop and microwave use, may result in a drink that is too hot, as the heating process, and therefore final temperature, is difficult to control. Using system 10 and external power source 42, the user may control the temperature that the milk may reach.

In some embodiments, external power source 42 may be used to decrease the temperature of a beverage inside container 12. External power source 42 may be arranged and configured to receive heat from a beverage inside container 12 via conductors comprising the bottom surface 14 and the flat surface of external power source 42, thereby reducing the temperature of the beverage inside container 12 within a predetermined threshold. This may be useful in cooling a beverage that would otherwise be too hot to drink.

For example, when brewing coffee, the temperature of the coffee is often a temperature that would not be comfortable to drink. When waiting for coffee to cool, the user may fail to drink it at its optimal temperature, and the user may end up with a cold cup of coffee. System 10 and power source 42 may be used to reduce and maintain a temperature within a predetermined threshold to allow the user to enjoy a hot cup of coffee that will not burn them. It should be appreciated that the beverage and predetermined threshold of temperature are in no way limited by the aforementioned examples.

Temperature regulating aspects of the system 10 may be controlled by one of the user and the system 10. The system 10 may be arranged and configured to control the temperature of a beverage automatically. As previously disclosed, the at least one sensor 20 can determine the type of beverage in container 12. The system 10 can be arranged and configured to warm or cool a beverage based on its beverage type as determined by the at least one sensor 20 using default parameters. As well, a user can utilize the software application coupled to remote computing device 30 to set optimal or desired temperatures for a variety of beverages. This information can be communicated to the system 10 to implement temperature control of a beverage in container 12.

The remote computing device 30 may be communicatively coupled to the external power source 42. This may allow the user to control and/or regulate temperature, power output level, battery mode, enable and/or disable the external power source 42, and the like. Allowing the user remote control over external power source 42 may aid the user in ease of use of the device.

In several embodiments, sidewall 18 may be comprised of insulating material or materials. As well, any lid 19 coupled with the system 10 may also be comprised of insulating material or materials. Using insulating material or materials in the construction of the sidewall 18 and a lid 19 coupled with system 10 may support the temperature control and/or regulation functions of system 10, and/or of system 10 coupled with external power source 42.

With reference to FIG. 1, at least one button 52 may be coupled to the container 12. The at least one button 52 may be located along the sidewall 18. The at least one button 52 may be communicatively coupled to the display screen 24 and the at least one sensor 20, and electrically coupled to the power source 26. The at least one button 52 may embody a button coupled to the container 12 protruding beyond the surface of the sidewall 18, a button coupled to the container 12 depressed below the surface of the sidewall 18, a digital button coupled to the container 12 arranged and configured to recognize fingerprints to operate, a digital button arranged and configured to be coupled to the display screen 24, and the like.

In some embodiments, the at least one button 52 can be arranged and configured to cause the at least one sensor 20 to capture at least one data 22a associated with the beverage inside container 12. The at least one button 52 can also be arranged and configured to dictate time intervals for the at least one sensor 20 when capturing the at least one data 22a.

For example, the at least one button 52 may cause the at least one sensor 20 to capture temperature data of a beverage inside container 12 over a ten minute period, reading the rate at which the temperature of a beverage may change. As well, the at least one button 52 may cause the at least one sensor 22a to capture time data of a beverage inside container 12. For example, the at least one data 22a may be the time period over which a user ingests a beverage. By monitoring how long it may take a user to finish a beverage, such as an alcoholic beverage, the user may be able to better regulate liquid consumption.

In some embodiments, the at least one button 52 may be arranged and configured to cause the display screen 24 to display an indication of the at least one data 22a associated with the beverage in container 12. The at least one button 52 may also allow navigation on display screen 24 of information associated with the system 10. This information may include a battery level, time, date, model number, serial number, software platform, enabled remote computing devices, currently connected remote computing devices, and the like.

As well, the at least one button 52 may be arranged and configured to cause the display screen 24 to display real time data associated with the at least one data 22a of a beverage inside container 12 captured from the at least one sensor 20. For example, a user may be able to monitor the temperature of their hot coffee and wait for it to reach a particular temperature before ingesting. In another example, a user drinking a cocktail with vodka and soda may be able to monitor the alcohol content of the beverage as they add more vodka, or more soda.

The at least one button 52 may control elements of the system 10, such as powering the system on and/or off, causing the display screen to sleep, causing the system 10 to enter a low power mode, causing the at least one sensor 20 to activate and/or deactivate, and the like. The at least one button 52 may also be used to inform the system 10 of the type of beverage is inside container 12 by selecting from a list of beverages on display screen 24, including, but not limited to, coffee, tea, milk, espresso, juice, beer, wine, soda, and the like.

In some embodiments, the at least one button 52 may be communicatively coupled to external power source 42. The at least one button 52 may cause the external power source 42 to power on and/or off, activate and/or deactivate heating elements, to enter a low power mode, and the like.

The network 60 may accommodate any different type of container 12 (e.g., a coffee cup, a beer mug, a baby bottle). In such cases, the at least one button 52 may communicate to the external power source 42 what type of container 12 may be currently coupled to the external power source 42. This may be useful if different containers 12 require different levels of power input from external power source 42.

In some embodiments, heating elements 54 may be coupled to the container 12, electrically coupled to the power source 26, and communicatively coupled to the at least one button 52. The heating elements 54 may be arranged and configured to heat at least one of the sidewalls 18 and the bottom surface 14 to thereby heat the beverage inside container 12. The heating elements 54 may be communicatively coupled to the at least one button 52 and the display screen 24. The at least one button 52 may be used to select from a variety of temperature control options on display screen 24 causing the heating elements 54 to activate, deactivate, change temperature, and the like.

In some embodiments, the sidewalls 18 and the bottom surface 14 may comprise a plurality of layers of materials. An inner lay may be comprised of conductive material or materials. An outer layer may be comprised of insulating material or materials. The inner layer may aid the heating elements 54 in heating a beverage inside container 12, while the outer layer may prevent loss of heat once the beverage has reached a predetermined threshold.

In some embodiments, the display screen 24 is arranged and configured to show a message, alert, and the like, to notify the user that the beverage inside container 12 has reached a predetermined temperature. In some embodiments, a speaker can be coupled to the display screen and/or the container 12. The speaker may be communicatively coupled to one of the display screen 24 and the at least one sensor 20. The speaker may be arranged and configured to notify a user of temperature changes, or other changes, to the beverage inside container 12.

The system 10 may notify the user of a temperature change of a beverage in the container 12 by producing an alert or message on the display screen 24. The system 10 may also be able to notify the user by producing an audible alert or message and broadcasting it via at least one speaker coupled to the system. The audible alert can be a nonverbal alert, such as a ding, ring, ping, beep, and the like. The audible alert can also be a verbal alert in the form of a prerecorded message. Prerecorded messages can be preconfigured in the system, or created by users using a remote computing device 30. It should be appreciated that the system 10 can notify the user of any function, like change in temperature of a beverage, using a message on display screen 24 and/or an audible message via the speaker or speakers.

For example, a user may fill the beverage container system 10 with room temperature or cold water, and activate heating elements 54 via at least one button 52 and/or at least one button 52 coupled with display screen 24. The system 10 may then heat the water to a predetermined temperature threshold and notify the user via the display screen 24 and/or the speaker. The user can then place a tea bag in the now hot water. This process may be useful to a person who does not have time to wait for water to boil, or does not currently have access to hot water.

Interpretation None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage. The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A beverage container system, comprising:
a container having a bottom surface, an open top, and a sidewall extending between the bottom surface and the open top, the container arranged and configured to receive a beverage;
at least one sensor coupled to the container, the at least one sensor arranged and configured to capture data associated with the beverage;
a display screen coupled to the container and communicatively coupled to the at least one sensor, the display screen located along the sidewall, the display screen arranged and configured to display at least one data associated with the beverage; and
a power source coupled to the container and electrically coupled to the display screen.

2. The system of claim 1, further comprising a communication module coupled to the container, communicatively coupled to the display screen, and electrically coupled to the power source.

3. The system of claim 2, further comprising a remote computing device communicatively coupled to the communication module.

4. The system of claim 3, wherein the remote computing device is communicatively coupled to the communication module via Bluetooth.

5. The system of claim 3, wherein the remote computing device comprises at least one of a smart phone and a tablet device.

6. The system of claim 3, wherein the remote computing device comprises a remote server, the system arranged and configured to determine an inventory level of an item associated with the beverage and automatically order, from a vendor, the item associated with the beverage at a predetermined time interval

7. The system of claim 3, wherein the remote computing device is arranged and configured to run a software application arranged and configured to allow a user to remotely control at least one of the display screen, the at least one sensor, and the power source.

8. The system of claim 1, wherein the at least one sensor is arranged and configured to determine at least one of a temperature of the beverage, a fill level of the beverage, and an inventory level of an item associated with the beverage.

9. The system of claim 1, wherein the power source comprises a battery.

10. The system of claim 1, further comprising a power input coupled to the container and electrically coupled to the power source.

11. The system of claim 10, wherein the power input comprises a USB Type-C port arranged and configured to receive power.

12. The system of claim 10, wherein the power input is arranged and configured to wirelessly receive power from an external power source.

13. The system of claim 12, wherein the external power source defines a flat surface configured to receive the bottom surface of the container.

14. The system of claim 13, wherein the external power source comprises a USB Type-C port arranged and configured to receive power.

15. The system of claim 13, wherein the external power source is arranged and configured to generate heat and conductively heat the bottom surface of the container when the bottom surface is physically placed on the flat surface.

16. The system of claim 1, further comprising at least one button communicatively coupled to the display screen, communicatively coupled to the at least one sensor, and electrically coupled to the power source.

17. The system of claim 16, wherein the at least one button is arranged and configured to cause the at least one sensor to capture the data associated with the beverage.

18. The system of claim 17, wherein the at least one button is arranged and configured to cause the display screen to display an indication of the data associated with the beverage.

19. The system of claim 16, further comprising a heating element coupled to the container, electrically coupled to the power source, and communicatively coupled to the at least one button, the heating element arranged and configured to heat at least one of the sidewalls and the bottom surface to thereby heat the beverage.

20. The system of claim 19, wherein the at least one button is arranged and configured to activate and deactivate the heating element.
